(19) United States
(12) Patent Application Publication
(10) Pub. No.: US 2011/0154247 A1
(43) Pub. Date: Jun. 23, 2011

(54) VIRTUAL CALENDAR

(75) Inventors: AL CHAKRA, APEX, NC (US); YONGCHENG LI, CARY, NC (US); YUPING C. WU, CARY, NC (US)

(73) Assignee: INTERNATIONAL BUSINESS MACHINES CORPORATION, ARMONK, NY (US)

(21) Appl. No.: 12/643,469

(22) Filed: Dec. 21, 2009

(51) Int. Cl. G06F 3/048

(52) U.S. Cl. 715/780

(57) ABSTRACT

A calendar event may be created by creating a data entry field and defining the event with the field. A template may be used to create the field. The template may contain a plurality of entry fields that may be user configurable, such as with a wizard, or selected from a palette of fields.

### BACKGROUND

The present invention relates, in general, to calendaring, and more specifically, to extending static calendar fields to virtual calendar fields.

Calendar software provides a useful tool to help people schedule their activities. Calendar tools allow basic functions of activity scheduling, reminding, basic collaboration and tracking. Current calendar fields allow a user to enter time, date, event description, and other useful information. A user may also set up recurring appointments by instructing the calendar to set up a series of similar appointments at chosen intervals. Calendars can be shared among members of a group and can be used to manage tasks/to-do's.

However, if a user wants to combine several calendar events or create a report based on a series of events, the user needs to manually gather the information. This may include opening and closing several different calendar events several times in order to cut-and-paste data from static calendar fields. Also, such cutting-and-pasting is limited to the data within predefined fields within the calendar program.

### BRIEF SUMMARY

In an embodiment of the present invention, a computer implemented method creates a calendar event. A virtual data entry field is defined, and the event is defined by combining the virtual data entry field with actual data entry fields.

In an embodiment of the present invention, a computer system creates a calendar event. A processor is programmed to define a virtual data entry field, and the event is defined by combining the virtual data entry field with actual data entry fields.

In an embodiment of the present invention, a computer program product creates a calendar event. The computer program product comprises a computer readable storage medium having computer readable program code embodied therewith. The computer readable program code is configured to define a virtual data entry field, and the event is defined by combining the virtual data entry field with actual data entry fields.

### BRIEF DESCRIPTION OF THE SEVERAL VIEWS OF THE DRAWINGS

FIG. 1 is a hardware diagram that may be used to implement an embodiment of the invention;

FIG. 2 illustrate a virtual event in accordance with an embodiment of the invention;

FIG. 3 illustrates the makeup of a virtual event of an embodiment of the present invention;

FIG. 4 illustrates a flowchart of an embodiment of the present invention;

FIGS. 5A, 5B, 5C, and 5D illustrate examples of actual events that may be used in accordance with an embodiment of the invention; and

FIG. 6 illustrates a template which may be used in accordance with the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

A computer readable signal medium may include a propagated data signal with computer-usable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that can contain, store, communicate, propagate, or transport a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

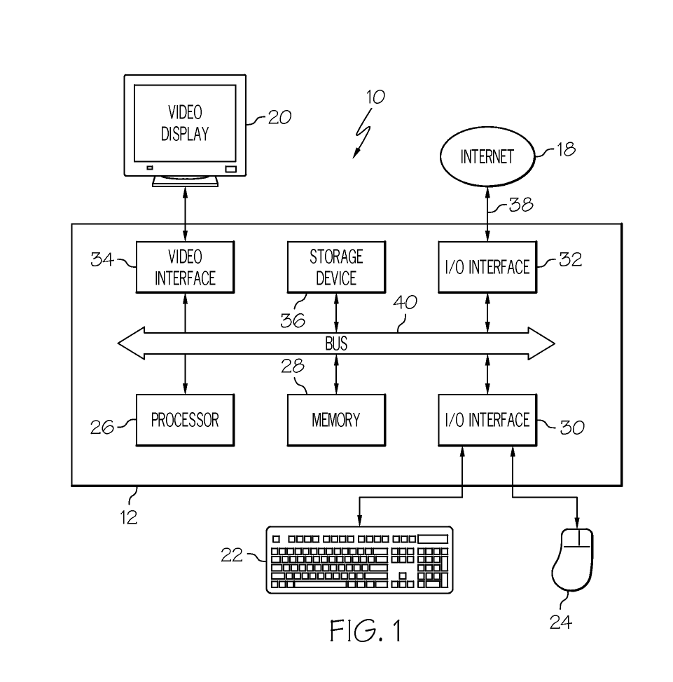

FIG. 1 is one example of a computer system 10 suitable for executing computer software for controlling presence awareness through bartering and policy control in a messaging system in accordance with the techniques described. Other processing devices which are suitable for executing the software can be a wireless telephone, personal assistant device (PDA), portable computer, smart remote control device, or any other processing devices that can execute such software.

The computer system 10 is of a type that executes under a suitable operating system installed on the computer system 10, and may be thought of as comprising software code for efficiently controlling presence awareness through bartering and policy control in a peer-to-peer messaging system. The components of the computer system 10 include a computer 12, a keyboard 22, mouse 24, and a video display 20. The computer 12 includes a processor 26, a memory 28, input/output (I/O) interfaces 30 and 32, a video interface 34, and a storage device 36.

The processor 26 is a central processing unit (CPU) that executes the operating system and the computer software executing under the operating system. The memory 28 includes random access memory (RAM) and read-only memory (ROM), and is used under direction of the processor 26.

The video interface 34 is connected to a video display 20 and provides video signals for display thereon. User input to operate the computer 12 is provided from the keyboard 22 and mouse 24. The storage device 36 can include a disk drive or any other suitable storage medium, as discussed above. Each of the components of the computer 12 is connected to an internal bus 40 that includes data, address, and control buses, to allow components of the computer 12 to communicate with each other via the bus 40. The computer system 10 can be connected to one or more other similar computers via an input/output (I/O) interface 32 using a communication channel 38 to a network, represented as the Internet 18.

The computer software may be recorded on a computer readable storage medium, in which case, the computer software program is accessed by the computer system 10 from the storage device 36. Alternatively, the computer software can be accessed directly from the Internet 18 by the computer 12. In either case, a user can interact with the computer system 10 using the keyboard 22 and mouse 24 to operate the programmed computer software executing on the computer 12.

As used herein, an event may be actual or virtual. For example, a Product X sales person has four actual customer events (meetings, presentations, etc.) with financial and manufacturing companies in North Carolina and South Carolina. These four actual events could all be grouped into a new virtual event called Product X Customer Sales Events. The Product X Customer Sales Event will not actually occur, as it is merely a grouping of four actual events, and is, therefore, a virtual event. Also, as used herein, “actual” (event or field) is equated to “calendar,” and both terms may be used interchangeably. As will be described in greater detail below, the creation of virtual events allows a user to summarize results and create reports based on the actual events.

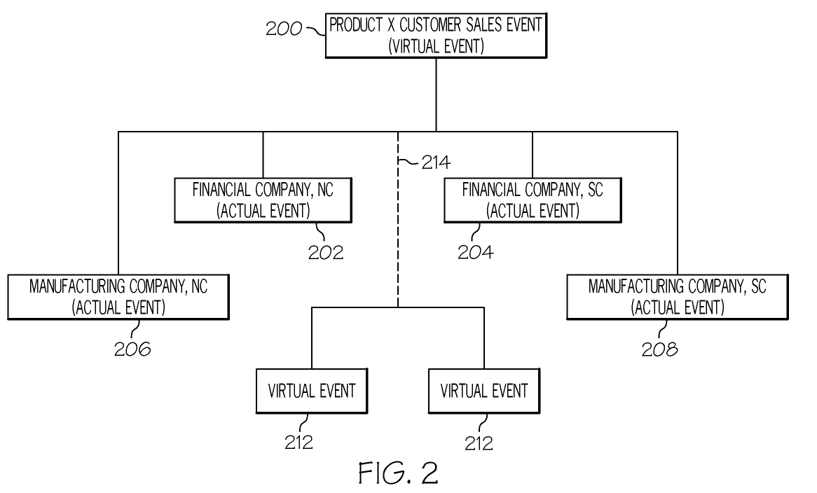

Referring to FIG. 2, the Product X Customer Sales Event (a virtual event) 200 is illustrated. In this example, the virtual event 200 comprises four actual events. The actual events are: a meeting with a Financial Company in North Carolina 202, a meeting with a Financial Company in South Carolina 204, a meeting with a Manufacturing Company in North Carolina 206, and a meeting with a Manufacturing Company in South Carolina 208. As shown by dashed line 214, virtual events 210 and 212 may also be part of virtual event 200, but for the sake of clarity, will not be discussed when referring to virtual event 200.

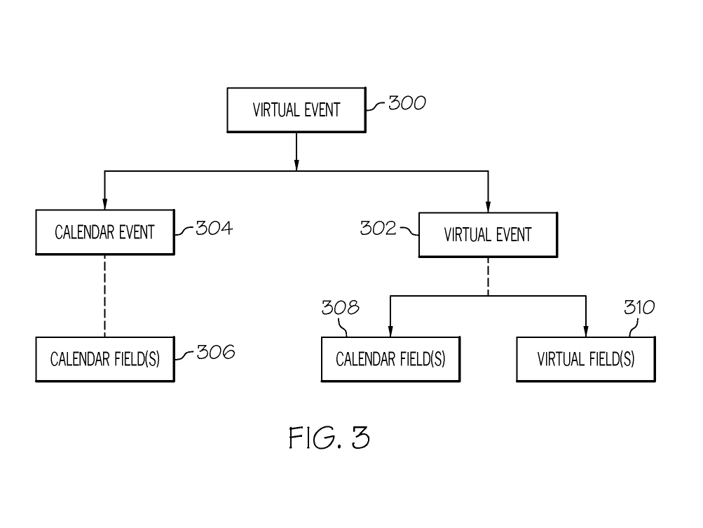

Referring to FIG. 3, a virtual event 300 may comprise a virtual event 302 and a calendar (actual) event 304. Each event 302 and 304 comprises a number of fields for data entry. As shown, the calendar event 304 comprises calendar (actual) fields 306. Calendar fields may comprise, for example, a date for the event, a time, a place, invitees, subject matter, etc.

Similarly, the virtual event 302 may comprise a number of calendar fields 308 and a number of virtual fields 310. Virtual fields 310 may also comprise the same type of fields as per a calendar field. In addition, a virtual field may be created by a user to fit any information desired for use in a summary and report after the calendar events have occurred. For example, if a user wanted to know all the attendees from Company A who were scheduled to attend the customer meeting with Company B, the user can create a virtual field for this criteria, and the field would be populated with the names. Although not shown, it is to be understood that an actual event may also be created using virtual fields to customize the actual event.

In one embodiment of the invention, a view representing a grouping of calendar events (including virtual events) can be assembled without creating an actual event. Using the example described above, the user may create several views within the Product X Customer Sales Event, for example:

1. A view of Product X Customer Sales Event for Financial Customers;

2. A view of Product X Customer Sales Event for Manufacturing Customers;

3. A view of Product X Customer Sales Event for NC Customers; and/or

4. A view of Product X Customer Sales Event for SC Customers.

In addition, summary reports may be automatically generated using virtual fields. For example, a time line of all the calendar events within a virtual event, a list of participants of all the calendar events within a virtual event, or a combination of fields from all the calendar events within a virtual event, may be created.

In accordance with an embodiment of the present invention, a user may create an event using, for example, templates, or queries. A template, as will be subsequently described in greater detail, allows field matching which may include using a rule to define a field or an event. For example, a field may be created to match all “sales events for financial companies” or “sales events for North Carolina.” Once the fields are created and matches are searched for, an output will display a view containing the matching results.

A new calendar or virtual event can be created based on existing virtual events. A relationship between calendar event fields can be established for convenience and consistency. For example, a sales person can create future virtual events for a Product X Customer Sales Event for New York Financial Customers and a Product X Customer Sales Event for New Jersey Manufacturing Customers. Then, if needed, a new future virtual event can be created for a Product X Customer Sales Event for New Jersey Financial Customers. A new calendar event can be created within this new virtual event by mapping the virtual Company Y field (local Company Y team) from the Product X Customer Sales Event for New Jersey Manufacturing Customers and the documentation/description field for financial customers from the Product X Customer Sales Event for New York Financial Customers. Whenever the local team members get updated in the Product X Customer Sales Event for New Jersey Manufacturing Customers, the local team in the participant field of Product X Customer Sales Event for New Jersey Financial Customers will also get automatic updates due to the inherent relationship defined.

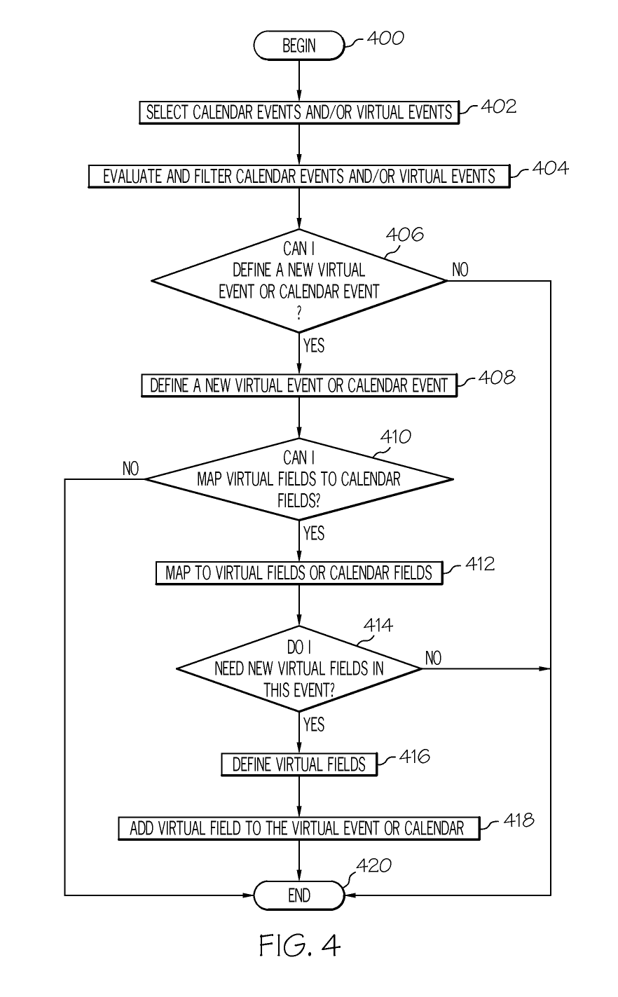

With reference now to FIG. 4, a flowchart illustrates an embodiment of the present invention. The process begins at block 400 and a user selects calendar events and/or virtual events at block 402. This could be accomplished using, for example, a graphical user interface, and/or a template, and/or a query.

At block 404, calendar events and/or virtual events are evaluated and filtered. Specifically, a user fills in, for example, a template to describe the virtual event for creation. A search is then conducted against the calendar database using the template. It is then determined at decision block 406 whether a new virtual event or calendar event can be defined (are there any matches?). If the response to decision block 406 is no, the process ends at 420.

If the response to decision block 406 is yes, a new virtual event or a new calendar event is defined at block 408. It is then determined at decision block 410 whether it is possible to map virtual fields to calendar fields. Specifically, it is determined if there are any existing fields and can they be mapped to fields for a virtual event. If the response to decision block 410 is no, the process ends at 420. If yes, mapping is done to virtual fields or calendar fields at block 414.

It is then determined at decision block 412 whether any new virtual fields are needed for this event. If the response to decision block 412 is no, the process ends at 420. If the response to decision block 412 is yes, new virtual fields are defined at block 416. The new virtual fields are added to the virtual event or calendar event at block 418, and the process ends at 420. Thus, a new virtual calendar event has been created using a template to search for and select the desired calendar information.

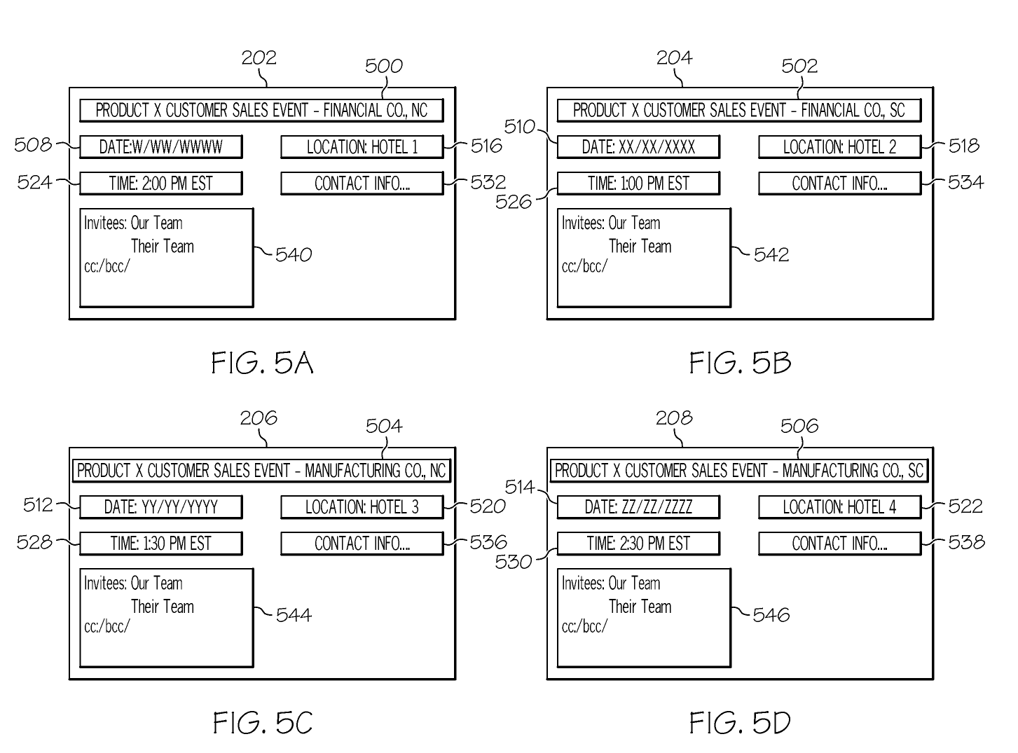

Referring to FIGS. 5A, 5B, 5C and 5D, actual calendar events, as previously described, are shown. FIG. 5A shows the actual calendar event 202 associated with the Product X Customer Sales Event for the Financial Company of North Carolina; FIG. 5B shows the actual calendar event 204 associated with the Product X Customer Sales Event for the Company of South Carolina; FIG. 5C shows the actual calendar event 206 associated with the Product X Customer Sales Event for the Manufacturing Company of North Carolina; and FIG. 5D shows the actual calendar event 208 associated with the Product X Customer Sales Event for the Manufacturing Company of South Carolina.

The actual events are each shown with some of the expected entries to provide the user with information about the event. For example, a description of the event 500, 502, 504, and 506, a date for the event 508, 510, 512, and 514, a location for the event 516, 518, 520, and 522, a time for the event 524, 526, 528, and 530, contact information for the event 532, 534, 536, and 538, and a list of invitees 540, 542, 544, and 546 for FIGS. 5A, 5B, 5C, and 5D, respectively. As can be seen, a Sales Event for Product X is scheduled with two different types of companies in two different locations on four different dates and times.

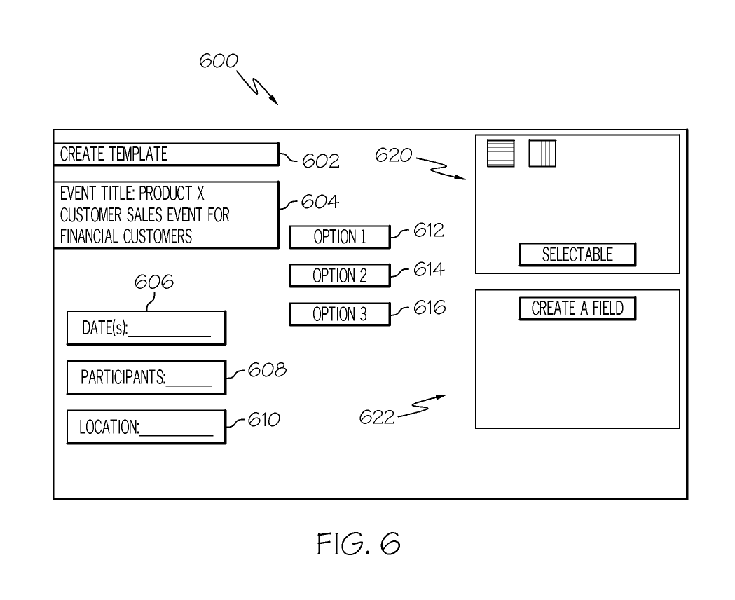

In order to create virtual events, in accordance with an embodiment of the invention, a template as described above may be used. Referring to FIG. 6, an example of a template 600 is shown using the “A view of Product X Customer Sales Event for Financial Customers” as an example. A “Create Template” dialog 602 is opened by a user and the Event Title field 604 is completed. The template 600 may be provided with a number of typical entries, such as, for example, Date(s) 606, Participants 608, and Location 610. Also provided may be Option fields 612, 614, and 616.

Using the “Create Template” dialog 602, a user may select fields from a palette 620. The palette 620 may contain a plurality of optional selectable fields, and by using the palette 620, the user is able to craft an event in a fashion similar to selecting widgets or parts in object-oriented-programming. In addition, a “Create a field” section 622, such as, a wizard, may be provided so that a user may create fields that are not already existing in either the typical or the selectable fields.

Although not shown, an embodiment of the invention may provide the user or a developer with the capability to write code that will create a new field. This may comprise use of an SQL type query that would be run against the calendar database.

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer implemented method for creating a calendar event, comprising:
providing a template to configure a virtual data entry field; and
combining said virtual data entry field and actual data entry fields with a computer processor to define the calendar event.

2. The computer implemented method of claim 1, wherein providing said template further comprises providing selectable virtual entry fields.

3. The computer implemented method of claim 2, wherein providing selectable virtual entry fields further comprises providing a wizard to enable creation of said virtual fields.

4. The computer implemented method of claim 1, wherein providing said template further comprises providing actual calendar fields and virtual calendar fields.

5. The computer implemented method of claim 1, wherein providing said template further comprises providing for creation of a calendar event summary with said template .

6. A computer system for creating a calendar event, comprising:
a template for configuring a virtual data entry field; and
a computing device for combining said virtual data entry field and actual data entry fields to define the calendar event.

7. The computer system of claim 6, wherein said template allows selection of virtual entry fields.

8. The computer system of claim 6, wherein said virtual entry fields are selected from user selectable fields.

9. The computer system of claim 6, wherein said virtual entry fields are created with a wizard.

10. The computer system of claim 6, wherein said template creates an event summary.

11. The computer system of claim 9, wherein said virtual entry fields are created from actual calendar fields and virtual calendar fields.

12. A computer program product for creating an event, the computer program product comprising:
a computer readable storage medium having computer readable program code embodied therewith, the computer readable program code comprising:
computer readable program code configured to define a virtual data entry field using a template; and
computer readable program code configured to combine said virtual data entry field with actual data entry fields to define the calendar event.

13. The computer program product of claim 12, further comprising computer readable program code configured to use said template to select said virtual field to define the event.

14. The computer program product of claim 12, further comprising computer readable program code configured to select said virtual field from user selectable fields.

15. The computer program product of claim 12, further comprising computer readable program code configured to create said virtual field with a wizard.
